(19) United States
(12) Patent Application Publication
(10) Pub. No.: US 2017/0017787 A1
(43) Pub. Date: Jan. 19, 2017

(54) AUTOMATICALLY SECURING AN ELECTRONIC DEVICE

(71) Applicant: Linkedln Corporation, Mountain View, CA (US)

(72) Inventor: Sean Lane, Chicago, IL (US)

(73) Assignee: LINKEDIN CORPORATION, Mountain View, CA (US)

(21) Appl. No.: 14/801,705

(22) Filed: Jul. 16, 2015

(51) Int. Cl. G06F 21/35

(52) U.S. Cl. CPC G06F 21/35

(57) ABSTRACT

A system, apparatus, and methods are provided for automatically securing an electronic device. The device is paired with a security token (e.g., an access badge) associated with a user authorized to operate the device. During device operation, if the security token (e.g., which may be worn or carried by the user) is out of range or proximity with the device, after a threshold period of time some or all functionality of the device (e.g., other than communication with the security token) is locked. Multiple modes of operation may be possible, during which the device looks for the security token within different ranges (or signal strengths) and/or uses different time thresholds. The security token may need to be in proximity to the device in order to unlock it (e.g., with a user login sequence), and the device may or may not unlock automatically when the token is proximate to the device.

### BACKGROUND

This disclosure relates to the fields of computers and communications. More particularly, a system, apparatus, and methods are provided for automatically securing a computer or other electronic device.

Computers, smartphones, and other electronic devices are subject to physical theft and/or unauthorized usage. Some schemes exist to physically secure such devices and/or to attempt to prevent unauthorized use of such devices, but may be place onerous demands on the device's user or owner. The more intrusive a security scheme, and the more effort it requires on the part of a device's user, the less likely it is that the scheme will be enforced or supported by the user.

For example, if a user must manually lock his or her device when it is not in use (e.g., with an access code or password), he or she may occasionally forget to lock it, or may knowingly fail to do so if such action is inconvenient at the time. Other schemes that apply automatically (e.g., when a user fails to interact with a device for some period of time) may leave a device vulnerable for a significant length of time before activating, thereby leaving the device open to unauthorized use.

### DESCRIPTION OF THE FIGURES

FIG. 1 is a block diagram depicting an environment in which an electronic device may be secured automatically, in accordance with some embodiments.

FIG. 2 is a flow chart illustrating a method of automatically securing an electronic device, in accordance with some embodiments.

FIG. 3 depicts a device that may be secured automatically, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, apparatus, and methods are provided for automatically securing use of a computer, a computing device, or other electronic device. In these embodiments, the electronic device is automatically secured when a security token that is paired with the device leaves the proximity of the device for a threshold period of time. The token is able to communicate with the device directly or indirectly, when in range, using communication elements internal and/or external to the device (e.g., an integrated circuit, a Universal Serial Bus or USB receiver or transceiver).

Proximity (or lack of proximity) between the security token and the electronic device may be determined based on the strength (or weakness) of a communication signal between the token and the device, and/or by some direct or approximate measure of a distance between the device and the token (if both items include geo-location components). In some implementations, the security token includes an RFID (Radio Frequency Identification) tag, which may be powered by an internal battery or a magnetic field produced by the device or by an RFID reader or interrogator operating in conjunction with the device. Depending on the operating frequency or frequencies of the tag, the device may be able to detect the token within a relatively short distance (e.g., 1 meter), a medium range (e.g., up to 10 meters), or a relatively long range (e.g., up to 100 or 200 meters).

In other implementations, other wireless communication technologies may be employed, which may use radio or infrared signals and any suitable communication protocol(s), such as Bluetooth®, Wi-Fi®, ZigBee®, LTE® (Long Term Evolution), WAP (Wireless Application Protocol), near field communications, and so on.

In some embodiments multiple wireless communication schemes may be employed, such as RFID and Bluetooth, in order to detect proximity of a security token to an electronic device within multiple ranges, or a single scheme may be employed that is capable of discerning different proximities (e.g., via multiple signal strength thresholds and/or multiple interface components cooperating with the device). For example, an IEEE 802.11 wireless communication protocol may be applied with received signal strength indicator (RSSI) or received channel power indicator (RCPI) readings, if the security token is configured with a compatible transmitter. Because an RSSI or RCPI component may be able to report multiple different power levels, it would be possible in this scenario to determine whether the security token is (or is not) within multiple different (approximate) ranges or proximities, wherein each range or proximity corresponds to a different power level.

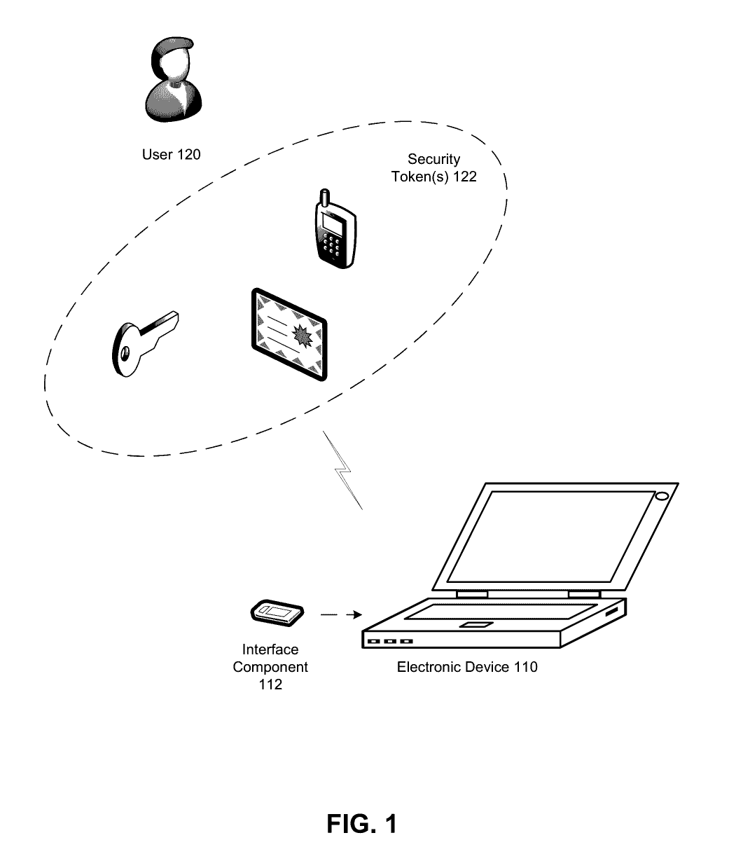

FIG. 1 is a block diagram depicting an environment in which an electronic device may be secured automatically, according to some embodiments.

In this environment, electronic device 110 is a portable computer (e.g., a laptop or notebook), but may be some other type of device in other embodiments (e.g., a desktop computer, a tablet computer). In addition, one or more security tokens 122 are associated with user 120, such as a badge (e.g., an access badge) or a smart card, a key or key fob, a smart phone, a smart watch, a smart band, a smart keychain, or some other token that is capable of communication with device 110 and that is associated with user 120. One or more of these tokens are possessed by and associated with user 120, and are paired with device 110 via interaction between the user and the device or via configuration from some other source (e.g., a security manager, a systems administrator, a vendor).

Device 110 includes one or more components capable of engaging in wireless communication with the security token(s) 122 that has or have been paired with the device. These components may be internal to device 110 (e.g., receiver embedded within the device, an application-specific integrated circuit, a radio transceiver) and/or external, such as interface component 112, which may be a USB receiver or transceiver. In some implementations, interface component 112 may be coupled to security token 122 when not connected to device 110 (e.g., for safe-keeping).

In embodiments in which device 110 communicates with a paired security token only via an external interface component that can be detached or disconnected from the device, when the component is detached the security scheme(s) provided herein may be unavailable. In some alternative embodiments, device 110 may operate normally only when the external interface is connected, thereby reducing or eliminating any incentive on the part of user 120 to disconnect the interface component.

Thus, a given security token 122 may include one or more components able to communicate with electronic device 110 (via a compatible internal or external communication component of the device, such as component 112), which may use any suitable wireless communication technology or technologies to communicate with the device within one or more ranges, and which may include technologies identified above and/or others, including those not now known but developed hereafter.

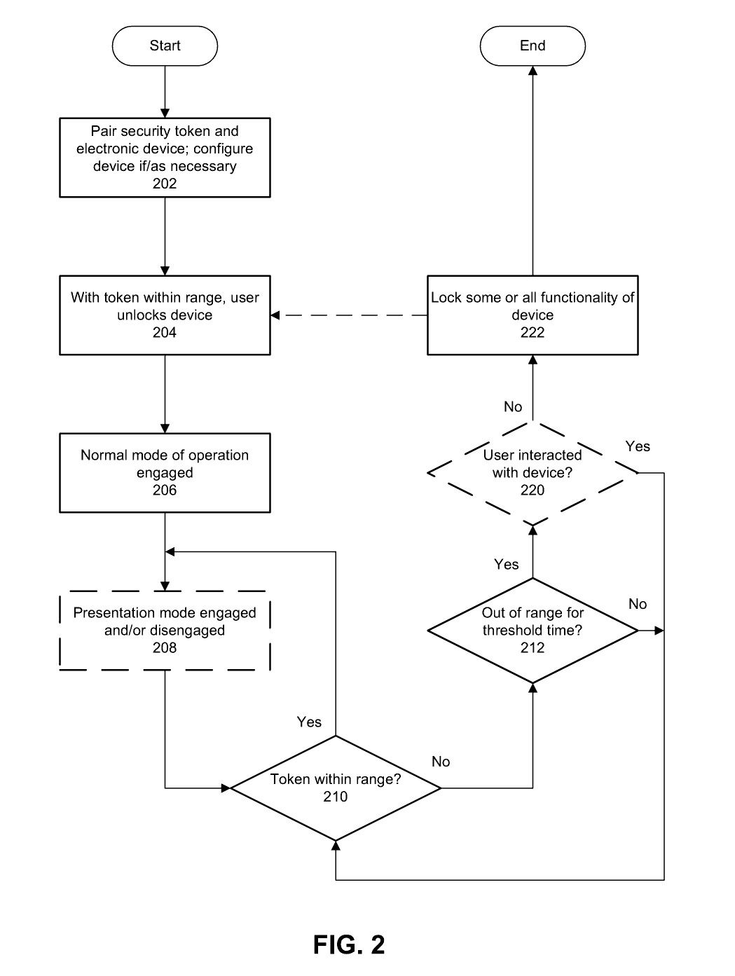

FIG. 2 is a flow chart illustrating a method of automatically securing an electronic device, according to some embodiments. In other embodiments, one or more of the illustrated operations may be omitted, repeated, and/or performed in a different order. Accordingly, the specific arrangement of steps shown in FIG. 2 should not be construed as limiting the scope of the embodiments.

In operation 202, a security token that is or that will be associated with a specific user is paired with a device operated by and/or belonging to that user. As indicated above, the token may be a security/identity/access badge, such as a badge used by an employee to access restricted areas of an organization, a key or key fob that may have other uses than as a security token (e.g., to operate a vehicle), a smart mechanism or gadget, or something else.

In an illustrative pairing process, a code or other value embedded or stored in the security token is associated with an identity of the device (e.g., an IP address, a MAC address), and/or the device is configured to identify the token's code or value as being authorized to access the device. The device may be paired with multiple different security tokens belonging to the same user or different users (e.g., if the device is operated at different times by different users), and the security token may be paired with multiple devices (e.g., if the user operates or may operate multiple devices).

In some embodiments, the pairing process is performed on behalf of an organization by a department or office that handles information technology and/or information security. Thus, as part of the process of provisioning a new employee's access within the organization or configuring a new or replacement device or token for an employee, his or her security token may be paired with one or more devices that he or she may operate.

In some other embodiments, the user may perform the pairing or someone may do so on the user's behalf. For example, the security token and/or the device may be purchased by the user for personal operation, and he or she may perform the pairing to enable the automated device security schemes discussed herein. Alternatively, a representative of a vendor of the security token and/or device may perform the pairing.

As part of the pairing process, or separate from the pairing process, the device may be configured to enforce automatic securing of the device, if it is not already so configured. For example, the operating system, an application, a utility, or a device driver may be installed that automatically locks the device (e.g., as if the user had logged out) when triggered (e.g., by lack of proximity of the security token for a threshold period of time). If the necessary driver(s), utility, application, or other software or hardware module was or were not already installed, they may be installed as part of operation 202, along with being configured to identify the user's security token(s).

If operation of the automated security scheme requires an external communication component for the device (e.g., a receiver or transceiver that connects to a port of the device), such as interface component 112 of FIG. 1, that component may be installed or provided to the user as part of operation 202. In different implementations, the device may or may not be fully operational without the external component attached to or connected to the device, but the automated security scheme may not function without it. Conversely, if the device includes multiple interface components, including a detachable external component, some portion of the scheme may still function.

Illustratively, in an organization that enforces good security practices, the device may be inoperable or may be unable to connect to the organization's network(s) or other organizational assets if/when the external interface component is separated from the device. Alternatively, specific applications may be inoperable (or less than fully operable) if the component is not connected to the device.

One of ordinary skill in the art of computer systems and computer security will recognize that various modifications may be required to be made to a personal device an organization's devices, and/or associated equipment (e.g., network components, other communication hardware, data servers, access control equipment) to support the automated security schemes discussed herein, which may differ from one type of device to another and from one operating environment to another.

In operation 204, with the security token in range of the device, the user unlocks the device (e.g., by logging in). Success in this operation may require the token's proximity, meaning that the user may not be able to unlock the device if the token is not within communication range of the device. Depending on the configuration of the token (e.g., active, passive), the type of wireless communication (e.g., radio, optical), the operating frequency or frequencies of the device's interface component(s), and/or other factors (e.g., line-of-sight between the device and security token, communication interference), in different implementations and different environments, proximity between the token and the device may involve different (approximate) distances or distance ranges.

The unlocking process thus necessarily includes establishing initial communication between the device and the security token, the process of which will depend upon the communication technology and protocol(s) they employ (e.g., RFID, Bluetooth, WLAN).

In operation 206, upon successful unlocking of the device by the user, the device enters a first or normal mode of operation of an automated security scheme. In this mode, the device remains fully operational as long as the security token remains within a first or normal range of the device (or of the interface component of the device that receives signals from and/or communicates with the security token—which may be internal or external to the device).

For example, if the security token includes an RFID tag operating in the high-frequency or global ISM (Industrial, Scientific and Medical) band (e.g., 13.56 MHz), and the device comprises a suitable reader or interrogator, or if the token and device communicate via Class 1 Bluetooth, this first range may be approximately 1 meter. If the security token includes a Bluetooth component that uses a Class 2 radio, the range may be approximately 10 meters. If the security token includes an IEEE 802.11 transceiver, the range may be tens of meters.

In some embodiments, a security scheme provided herein replaces or supersedes a normal time-out or lock-out period that is otherwise applied by the device. For example, if the device is a computer that normally locks or logs the user out after a period of inactivity, that feature may be deactivated when the security scheme is active. Other features (e.g., blanking a screen, activating a screen saver, turning off a device component (other than a component used to communicate with the security token)) may or may not remain active.

In optional operation 208, a second or presentation mode of operation is engaged, which terminates/suspends the first or normal mode, or the second/presentation mode terminates, in which case the first/normal mode resumes. In particular, only one or the other of the first mode and second mode is generally active at a given time.

Presentation mode may commence automatically when the user initiates an application on the device that can continue to operate normally without the user being in proximity to the device or interacting with the device, and/or may be engaged manually by the user. Presentation mode may terminate automatically when the application terminates, and/or after a default period of time (which may differ from threshold time periods that cause the device to be automatically secured).

Whereas normal mode of operation of the automated security scheme generally involves direct contact between the user and the device (e.g., as the user manipulates a keyboard to write an electronic mail note, draft some other document, write some program code, or modify a spreadsheet) or at least relatively close proximity between the user's security token and the device, presentation mode may involve operation of a program for displaying a presentation or engaging in a conference (e.g., a web conference, a video conference), during which the user may remotely control the device (e.g., wirelessly) or allow someone else to operate the program while the user is addressing an audience or otherwise straying from proximity with the device. Thus, during presentation mode, the security token may be moved out of the first or normal range of proximity with the device (e.g., if worn or carried by the user), but may remain within the second or presentation range of proximity.

As discussed previously, either or both the normal range and presentation range may be associated with threshold strengths of signals received by the device from the security token. Also, different components of the device may be associated with the different ranges. For example, a determination as to whether the token is within the first/normal range may be made by an RFID reader/interrogator that interacts with a short-range/high-frequency RFID tag within the token, while a determination as to whether the token is within the second/presentation range may be made by a Bluetooth master that interacts with the token via Class 2 radio communications.

In operation 210, the device determines whether the security token is within the required range—the first range if the normal mode of operation is engaged, or the second range if the presentation mode is active. This determination may involve determining whether any signal is received from security token and/or examining the strength of a signal received from the token. If the token is detected within the operative range, the method returns to a previous operation (e.g., if the mode changes) or may continually or periodically determine whether the token is within the required range as long as the current mode continues (e.g., every second, every 10 seconds, every minute). Otherwise, the method continues to operation 212.

In operation 212, the device determines whether the token has been out of range for a threshold period of time. The time threshold may vary from one mode to another, or the same threshold may apply to every mode. Illustratively, a first time threshold associated with the normal mode of operation may be on the order of minutes (e.g., 1 minute, 5 minute, 15 minutes), while a second time threshold associated with the presentation mode of operation may be on the order of minutes or hours (e.g., 30 minutes, 1 hour, 2 hours). If the applicable time threshold has passed, the method continues at operation 220; otherwise, the method returns to operation 210 or some earlier operation (e.g., if the mode changes).

In some implementations, no time threshold may apply. In other words, as soon as the security token is out of proximity with the device (i.e., it is not detected within the applicable range), the method may proceed directly to operation 220 or operation 222.

In optional operation 220, the device determines whether the user (or a user) interacted with the device during the applicable threshold period of time. Illustratively, the user associated with the device and the security token may be in the vicinity of the device, but outside the applicable range, while supervising or allowing someone else to operate the device. In these circumstances, the device may assume that it is being operated with the associated user's permission, and therefore refrain from engaging the otherwise-automatic security lockout.

In operation 222, because the token has been out of range/proximity of the device for the threshold period of time, the security scheme automatically locks the device or logs the user out, thereby preventing use of any/all features of the device. In other implementations, the device may be only partially deactivated or locked. For example, some communication capabilities may be deactivated—such as communication with an organization's network—but not communication with the security token.

After operation 222, the method may end or may return to an earlier operation (e.g., operation 204) if the security token is again in range of the device. In some implementations, when the token is again in range after the device has been secured, the user must again login or manually unlock the device (e.g., as in operation 204).

In some other implementations, the device may unlock automatically when the token is again in range. Yet further, a subset of these other implementations may only apply if the token comes back in range within another predetermined threshold period of time that commences after the device's functionality is locked.

In some embodiments, a user's associated device may cooperate with other communication/computing equipment for the purpose of applying an automatic security scheme, such as when or whether to automatically lock or unlock the device.

For example, if the device operates within an organization having (wireless) communication capabilities connecting distributed computing and communication equipment, the device may query a presence or location service within the organization to determine whether the user is detected within the organization's work area or an area in which the device is operated. This service may record when the user enters or exits a particular area (e.g., by using his or her badge to open a door), may determine that the user is operating or has logged into a nearby device, and/or may periodically record the user's (approximate) location (e.g., via communication between the security token and equipment associated with the service).

If the user is determined to be within the same work area, building, floor, or other area controlled by the organization, but his or her security token is beyond the applicable range of the device, the device may extend an applicable time threshold monitored in operation 212 of the method of FIG. 2, may cause the device to unlock automatically when the token is again proximate to the device (i.e., instead of requiring another login), or may otherwise modify the security scheme to make it more user-friendly.

Similarly, however, the organization's computing system may inform the device when the user departs the organization's work area (e.g., by exiting an external door), in which case operation 212 of the method of FIG. 2 may be aborted and the method may proceed immediately to operation 222.

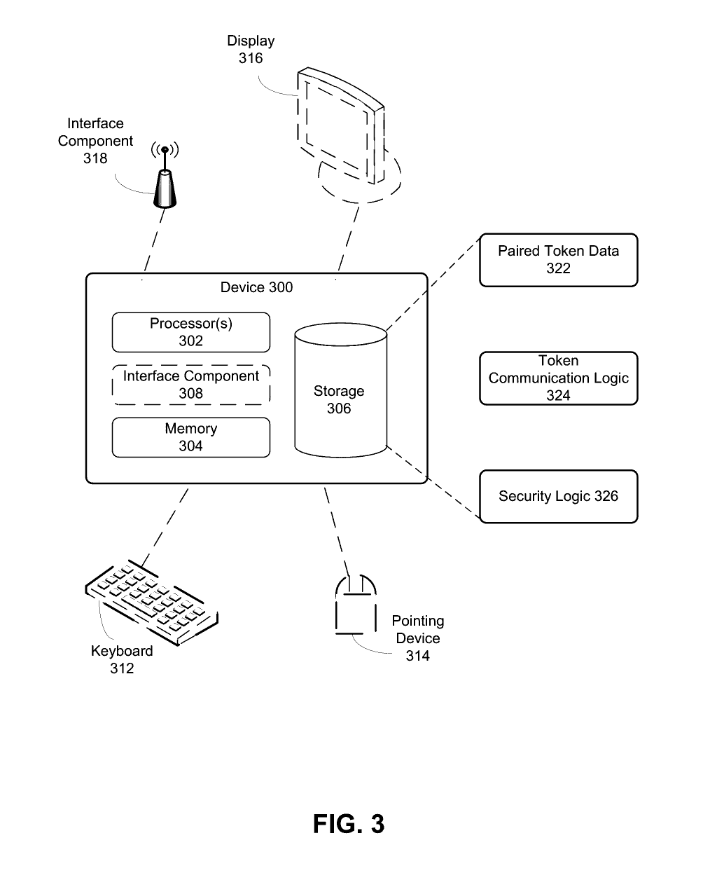

FIG. 3 depicts a device that may be secured automatically, according to some embodiments.

Device 300 of FIG. 3 includes processor(s) 302, memory 304, optional internal token interface component 308, and storage 306, which may comprise one or more optical, solid-state, and/or magnetic storage components. Storage 306 may be local to or remote from the device. Some types of device 300 (e.g., computing devices) can be coupled (permanently or temporarily) to keyboard 312, pointing device 314, display 316, and external interface component 318.

The device may include either or both interface components 308, 318, and each may be able to communicate with one or more security tokens associated with one or more authorized users of device 300. Different interface components may communicate with different types of security tokens using the same or different communication technologies/protocols, and may be able to detect tokens at the same and/or different ranges or proximities.

Storage 306 stores paired token data 322, which identifies security tokens with which device 300 has been paired. This data may include token identifiers, codes, user identifiers, and/or other information. Device 300 may only be operable in a normal manner when one of the corresponding paired tokens is proximate to the device.

Storage 306 also stores logic that may be loaded into memory 304 for execution by processor(s) 302. Such logic includes token communication logic 324 and security logic 326. In other embodiments, a logic module may be divided to separate its functionality as desired, or multiple logic modules may be combined or merged.

Token communication logic 324 comprises processor-executable instructions for communicating with one or more security tokens through one or more compatible interface components. Logic 324 may therefore be capable of interrogating a token to determine its identity and/or associated user, and/or may be capable of receiving such information from a token without first being interrogated.

Security logic 326 comprises processor-executable instructions for applying an automated security scheme described herein. Logic 326 therefore sets or determines an applicable mode of operation (e.g., normal, presentation), determines whether a paired security token is within the applicable proximity (on a continual, periodic, or regular basis), determines whether the token has been out of range or proximity for a threshold period of time, and automatically locks or secures some or all functionality of the device when appropriate.

Security logic 326 or one or more separate logic modules may also perform other functions described herein, such as detecting (authorized) user activity while a token is out of proximity, interacting with other communication/computing resources to possibly modify a security scheme if it can be determined that an associated user is relatively nearby even though his or her token is out of proximity, querying other equipment to determine a user's location, and so on.

In some embodiments in which an automated security scheme is applied within an organization, if a user loses or misplaces his or her associated security token that is paired with an electronic device, he or she may be given a temporary token, and the device may be configured directly or remotely (e.g., by a member of the organization's information technology team) to accept the temporary token for a specified or predetermined temporary period of time (e.g., twelve hours, one day). The lost/misplaced token may be temporarily or permanently unpaired from the device.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method of automatically securing an electronic device, the method comprising:
pairing a security token with the electronic device, wherein the security token and the electronic device communicate at least temporarily when the security token is within communication range of the electronic device; and
at the electronic device:
detecting lack of proximity of the security token; and
automatically disabling one or more features of the electronic device upon said detection of lack of proximity of the security token.

2. The method of claim 1, further comprising, at the electronic device and prior to said detecting lack of proximity of the security token:
detecting proximity of the security token during a manual unlocking of the electronic device by a user.

3. The method of claim 2, wherein the user is unable to manually unlock the electronic device when the security token is not within proximity of the electronic device.

4. The method of claim 1, wherein said detecting lack of proximity of the security token comprises one or more of:
detecting lack of proximity of the security token within a first distance; and
detecting lack of proximity of the security token for at least a threshold period of time.

5. The method of claim 4, wherein said detecting lack of proximity of the security token within the first distance comprises:
receiving no signal from the security token; or
receiving a signal from the security token having no greater than a predetermined strength.

6. The method of claim 1, further comprising, at the electronic device:
determining, at least periodically, whether the security token is within a first proximity;
wherein the first proximity is associated with a first approximate distance.

7. The method of claim 6, wherein the first approximate distance is a communication range of a first interface component of the electronic device configured to communicate with the security token.

8. The method of claim 6, further comprising:
initiating a presentation mode upon activation of a presentation application on the device; and
during the presentation mode:
determining, at least periodically, whether the security token is within a second proximity;
wherein the second proximity is associated with a second approximate distance different than the first approximate distance.

9. The method of claim 1, further comprising, at the electronic device after said detecting lack of proximity of the security token:
receiving from an external location service a location of the security token; and
after detecting return of the security within proximity of the electronic device, automatically unlocking the one or more features of the electronic device only if the location was within an operating area of the electronic device.

10. A device, comprising:
one or more processors; and
memory storing instructions that, when executed by the one or more processors, cause the device to:
pair a security token with the device, wherein the security token and the device communicate at least temporarily when the security token is within communication range of the device;
detect lack of proximity of the security token; and
automatically disable one or more features of the device upon said detection of lack of proximity of the security token.

11. The device of claim 10, wherein the memory further stores instructions that cause the device to, prior to said detecting lack of proximity of the security token:
detect proximity of the security token during a manual unlocking of the electronic device by a user.

12. The device of claim 11, wherein the user is unable to manually unlock the electronic device when the security token is not within proximity of the electronic device.

13. The device of claim 10, wherein said detecting lack of proximity of the security token comprises one or more of:
detecting lack of proximity of the security token within a first distance; and
detecting lack of proximity of the security token for at least a threshold period of time.

14. The device of claim 13, wherein said detecting lack of proximity of the security token within the first distance comprises:
receiving no signal from the security token; or
receiving a signal from the security token having no greater than a predetermined strength.

15. The device of claim 10, wherein the memory further stores instructions that cause the device to:
determine, at least periodically, whether the security token is within a first proximity;
wherein the first proximity is associated with a first approximate distance.

16. The device of claim 15, wherein the first approximate distance is a communication range of a first interface component of the electronic device configured to communicate with the security token.

17. The device of claim 15, wherein the memory further stores instructions that cause the device to:
initiate a presentation mode upon activation of a presentation application on the device; and
during the presentation mode:
determine, at least periodically, whether the security token is within a second proximity;
wherein the second proximity is associated with a second approximate distance different than the first approximate distance.

18. The device of claim 10, wherein the memory further stores instructions that cause the device to, after said detecting lack of proximity of the security token:
receive from an external location service a location of the security token; and
after detecting return of the security within proximity of the electronic device, automatically unlock the one or more features of the electronic device only if the location was within an operating area of the electronic device.
